(19) United States
(12) Patent Application Publication
(10) Pub. No.: US 2018/0281341 A1
(43) Pub. Date: Oct. 4, 2018

(54) FIBRE-CONTAINING SHEET COMPRISING A FOLDING PATTERN AND METHOD OF PRODUCING THE SAME

(71) Applicant: Innventia AB, Stockholm (SE)

(72) Inventors: Hjalmar Granberg, Norrköping (SE); Anna Nilsson, Stockholm (SE); Hanna Skoglund, Västra Frölunda (SE)

(21) Appl. No.: 15/762,434

(22) PCT Filed: Sep. 1, 2016
(86) PCT No.: PCT/SE2016/050823

§ 371 Date: Mar. 22, 2018

(30) Foreign Application Priority Data
Sep. 25, 2015 (SE) 1551232-0

(51) Int. Cl. B32B 3/28; B29C 53/04; B29C 53/24; B65D 65/40; B31D 3/00; B31D 5/04; B31D 3/04

(52) U.S. Cl. CPC B32B 3/28; B29C 53/04; B29C 53/24; B31D 2205/0052; B31D 3/002; B31D 5/04; B31D 3/04; B65D 65/406

(57) ABSTRACT

A fibre-containing sheet comprising a folding pattern and a partly or fully folded sheet product obtained from the fibre-containing sheet is disclosed. The folding pattern of the fibre-containing sheet comprises a series of parallel straight fold lines and a series of zigzag fold lines. Each zigzag fold line has a breadth which is greater than a breadth of a straight fold line. The partly folded sheet product can be shaped into various complex geometrical shapes, including spheres and saddle points, as a result of the folding pattern. A method for producing the fibre-containing sheet as well as use of the fibre-containing sheet is also disclosed.

### TECHNICAL FIELD

The present disclosure relates in general to the field of a fibre-containing continuous sheet comprising a folding pattern, a partly or fully folded sheet product, as well as a method for producing a fibre-containing continuous sheet comprising a folding pattern.

### BACKGROUND

A conventional paper sheet may be bent in a plurality of directions. However, there are certain limitations in the obtainable geometrical bending forms. For example, it is not possible to bend a flat continuous paper sheet such that it comprises a saddle point on the surface of the sheet. In a saddle point, a surface of a sheet curves up in one surface direction and curves down in a different e.g. orthogonal surface direction. FIG. 1 schematically illustrates a surface of a sheet 1 having a saddle point, SP. It can be seen that in the direction X_{SP}, the sheet curves downwards whereas in the direction Y_{SP}, perpendicular to the direction X_{SP}, the sheet curves upwards, starting from the saddle point SP. The surface is thus double curved. Due to the fact that such a geometrical form cannot be achieved for a paper sheet as such, it is also difficult to obtain such a form in a paperboard or the like made of continuous sheets or layers. There is a desire to enable more complex geometrical forms of paper as well as cardboard, for example in order to enable new packaging solutions.

One alternative to obtain more complex geometrical shapes is to provide for example slits or the like in the continuous paper sheet. The slits are intended to accommodate for certain deformation of the sheet by widening of the slits. However, such a solution does not provide a continuous surface of the sheet after the sheet has been formed to the intended geometrical shape and may also increase the risk for tear or break as a result of the end of the slits acting as initiation points therefore.

In contrast to conventional paper, a textile may, depending on the specific textile, provide a greater flexibility in the possible geometrical forms which may be obtained. Recently, various kinds of textile-like materials comprising cellulose fibres have been developed. One such example is PLA-paper, which is a sheet of a composite comprising fibres from both pulp and polylactide (PLA). PLA may also be added in other forms, such as particulate form, in PLA-paper.

Polylactide (PLA) is a biodegradable thermoplastic aliphatic polyester derived from renewal resources. PLA is also a commonly used as a generic term for PLLA, PDLA and PDLLA, either alone or in mixture of any combination thereof. PLA may be prepared by polymerization of lactic acid through fermentation of corn starch, cane sugar or other bio-products with high starch content. PLA may also be obtained by direct condensation of lactic acid monomers. PLA can be processed for example into fibres or films. It may also be injection moulded, extruded or thermoformed. PLA has a glass transition temperature (T_{g}) of about 50-70° C. and a melting point (Tₘ) of about 170-190° C.

PLA has recently gained a lot of interest in the forest industry for being biobased and biodegradable, and thus environmentally friendly. Pulps comprising PLA (pulp-PLA) have been investigated and can be used for various processes. Pulp-PLA is a composite made from a mixture of cellulosic fibre and PLA. The ratio between the two components can be altered depending on the intended application. Furthermore, different types of pulps may be used in pulp-PLA.

Pulp-PLA composites can be used in two different states, broadly classified as activated and non-activated. When the composite is in its non-activated state, the composite possesses properties similar to textiles and is consequently quite flexible. In its activated state, when it has been subjected to heat or to heat and pressure, the PLA of the composite melts and the properties of the composite turn more plastic-like making the composite strong, rigid and dimensionally stable. Thus, when the PLA has been melted, the composite no longer possesses textile-like properties.

PLA-paper may be produced from a pulp-PLA in conventional paper machines. Creping of such a paper improves the textile-like properties. Using heat to melt the PLA of the material gives the material a plastic appearance. Thus, the properties of PLA-paper can be tailored to the intended use. Moreover, using thermoforming, pulp-PLA can be turned into a light weight composite and injection moulding can create rigid structures. It is also possible to 3D-print the composite.

Thus, with the usage of a conventional paper machine and conversion techniques, pulp-PLA can be produced and transformed to achieve different properties and functions such as to suit a range of different applications. In fact, the bio-based pulp-PLA may be used in a wide range of applications where fossil materials are being used today. Examples of such applications include, but are not limited to, packaging materials and sanitary articles.

A disadvantage of textile-like PLA-paper is that it has proved to be relatively weak compared to conventional paper and conventional fabric. There is therefore a desire to improve the strength thereof without compromising with its textile-like properties.

### SUMMARY

The object to be achieved is a fibre-containing sheet which can be bent in multiple directions such as to achieve various geometrical shapes, such as a sphere or a saddle point, without the need for slits or the like adapted to widen in order to enable the deformation needed to obtain the geometrical shape.

The object is achieved by means of a fibre-containing continuous sheet according to claim 1, a partly or fully folded sheet product according to claim 13 and a method for producing a fibre-containing continuous sheet according to claim 17.

More specifically, the object is achieved by providing a substantially planar fibre-containing sheet with a folding pattern enabling the sheet to be bent to various geometrical shapes when in a partly folded state. The folding pattern comprises zigzag fold lines and straight parallel fold lines, and the breadth of each zigzag fold line is purposively selected to be greater that the breadth of any one of the straight fold lines. Thereby, the fibre-containing sheet will, during folding and/or subsequent shaping of a partly folded sheet into a desired geometrical shape thereof, have a flexibility in the obtainable angle between the fold lines where the fold lines intersect. More specifically, the angle is not restricted to the main course of the fold lines, i.e. the angle defined by the folding pattern as such, but has a certain degree of freedom as a result of the breadth of the zigzag fold lines. Thereby, more complex geometrical shapes can be formed of the sheet without risking the sheet to tear, crack or otherwise break during such shaping, and without the need of slits or the like in the sheet to enable the intended geometrical shape of the partly folded sheet product.

The fibre-containing sheet according to the present invention comprises a folding pattern with fold lines and facets. The folding pattern consists of a series of parallel straight fold lines extending in a first surface direction of the sheet and a series of zigzag fold lines extending in a second surface direction of the sheet. The second surface direction is preferably perpendicular to the first surface direction. The straight fold lines are intersected by the zigzag fold lines, and each zigzag fold line alters course at each and every intersection with a straight fold line. The straight fold lines and zigzag fold lines together define a grid of facets, wherein each facet is parallelogrammatic in shape. Each zigzag fold line has a breadth b that is greater than a breadth a of any one of the parallel straight fold lines, wherein fold line breadth is measured perpendicular to the course of the fold line. The fibre-containing sheet is preferably a continuous sheet.

The fibre-containing sheet preferably comprises cellulose fibres.

The fibre-containing sheet may suitably comprise cellulose fibres, and fibres or particulates of at least one of polylactide (PLA), polyhydroxyalkanate (PHA), caprolactam (CPL) and thermoplastic starch (TPS). The fibres or particulates of at least one of polylactide (PLA), polyhydroxyalkanate (PHA), caprolactam (CPL) and thermoplastic starch (TPS) may be homogenously distributed in the sheet, or only present in a first part of the sheet constituting the facets.

A ratio of the bending stiffness in a first part of the sheet constituting the facets to the bending stiffness in a second part of the sheet constituting the fold lines may suitably be at least 2:1, preferably at least 3:1, more preferably at least 5:1.

A first part of the sheet constituting the facets may be stiffened in relation to a second part of the sheet constituting the fold lines. Stiffening of the first part constituting the facets increases the bending stiffness thereof and thereby inter alia further facilitates the handling of a partly folded sheet product obtained from the fibre-containing sheet as well as further ensures that the facets remain flat during folding of the fibre-containing sheet and/or during subsequent shaping of a partly folded sheet product obtained from the fibre-containing sheet.

Stiffening of the first part of the sheet constituting the facets may be achieved by application of a coating or a layer to the first part of the sheet. Stiffening may also be achieved by impregnating or soaking the first part of the sheet with a stiffening agent. Alternatively or in addition, stiffening of the first part of the sheet constituting the facets may be achieved by welding, hardening or thermopressing of the first part of the sheet.

Each of the zigzag fold lines may have the same breadth b, but it is also plausible that two adjacent zigzag fold lines have different breadths. Each of the parallel straight fold lines may suitably have the same breadth a.

The breadth b may suitably be at least twice that of breadth a. Increasing the breadth b increases the degree of freedom for the α-angle to adopt different values during folding or subsequent shaping of a partly folded sheet product. Preferably, the ratio of the breadth b of a zigzag fold line to the breadth a of a straight fold line may be from 2.5:1 to 5:1.

A distance between any two subsequent parallel straight fold lines c and a distance between any two subsequent fold lines d may suitably be within a ratio of from 1:5 to 5:1, wherein the distance between two fold lines is measured perpendicular to the course of the fold lines. This inter alia ensures that the facets have an appropriate size and thereby can remain flat during folding.

The ratio of the distance between any two subsequent zigzag fold lines d and the breadth of each zigzag fold line b may suitably be from 2:1 to 10:1, preferably from 2.5:1 to 7:1. This inter alia ensures that the facets are large enough to provide sufficient stability to the fibre-containing sheet during folding.

The folding pattern comprises an acute angle (α₀) formed by the intersection of the zigzag folding lines and the straight folding lines when the sheet is in a flat unfolded state. Said acute angle is thus defined by the folding pattern as such, and may suitably be from 50° to 85°, preferably from 55° to 75°.

Each facet may have rounded corners at least where the zigzag fold lines and the straight fold lines intersect to form an acute angle. The rounded corners provide an even greater degree of freedom for the α-angle to adopt different values, and thus enable even more complex geometrical shapes to be formed of a partly folded sheet product obtained from the fibre-containing sheet comprising the folding pattern.

The fibre-containing sheet may be a creped sheet. Creping increases the flexibility and stretchability of the sheet and thus reduces the bending stiffness of the sheet at least in the part constituting the fold lines.

The fibre-containing sheet disclosed above may, from an originally substantially flat state (i.e. where the fibre-containing sheet comprising the folding pattern is substantially planar), be folded to a partly or fully folded sheet product. The partly or fully folded sheet product obtained comprises mountain folds as well as valley folds. Each zigzag fold line consists solely of mountain folds or solely of valley folds, with mountain folds alternating with valley folds from one zigzag fold line to an adjacent zigzag fold line. Each of the straight fold lines alternates between valley folds and mountain folds in correlation with each intersection with a zigzag fold line.

The fibre-containing sheet according to the present invention may be flat-folded in one direction only or in two perpendicular directions if desired.

The present invention also relates to a laminate comprising a partly folded sheet product as disclosed above and at least one liner.

The present invention also relates to a cardboard or paperboard comprising a partly folded sheet product as disclosed above and at least one second fibre-containing sheet. The partly folded sheet product may suitably be used as a flute interposed between two liners each constituting a second fibre-containing sheet.

The present invention also relates to a packaging material comprising a partly folded sheet product as disclosed above, and optionally one or more additional sheets or layers.

The present invention also relates to a method of producing a fibre-containing sheet. The method comprises the steps of providing a fibre-containing sheet, preferably a fibre-containing continuous sheet, and forming a folding pattern on said sheet such that the folding pattern comprises a series of parallel straight fold lines in a first surface direction of the sheet, the straight fold lines being intersected by zigzag fold lines extending in a second surface direction of the sheet, each zigzag fold line altering course at each and every intersection with a straight fold line, the straight fold lines and zigzag fold lines together defining a grid of facets, wherein each facet is parallelogrammatic in form, and wherein each zigzag fold line has a breadth b that is greater than a breadth a of any one of the parallel straight fold lines, wherein fold line breadth is measured perpendicular to the course of the fold line. The fibre-containing sheet comprising the folding pattern may be any of the above described fibre-containing sheets comprising a folding pattern.

The method may further comprise a step of reducing the bending stiffness in the part of the sheet constituting the fold lines compared to the bending stiffness of the fibre-containing sheet before the folding pattern is formed.

The method may further comprise the step of stiffening a first part of the sheet constituting the facets in relation to a second part of the sheet constituting the fold lines. This increases the bending stiffness of the first part of the sheet compared to the bending stiffness of the sheet before the folding pattern is formed.

The first part of the sheet constituting the facets may be stiffened by applying a coating or layer to the first part of the sheet or by impregnating the first part of the sheet. Alternatively or in addition, the first part of the sheet constituting the facets may be stiffened by welding, hardening, or thermopressing of said first part of the sheet.

The method may further comprise folding the above described fibre-containing sheet such as to obtain a partly or fully folded sheet product. Thus, the method may further comprise at least partly folding the sheet along the fold lines in order to form mountain folds and valley folds, wherein each folded zigzag fold line consists solely of mountain folds or solely of valley folds, with mountains folds alternating with valley folds from one zigzag fold line to the subsequent zigzag fold line, and wherein each of the folded straight fold lines alternates between valley folds and mountain folds in correlation with each intersection with a zigzag fold line.

The method may further comprise creping the sheet prior to forming the folding pattern.

In case of the method comprising stiffening of the part constituting the facets, the method may further comprise creping the sheet after forming the folding pattern but prior to stiffening the facets.

### BRIEF DESCRIPTION OF DRAWINGS

FIG. 1 illustrates a perspective view of a sheet formed into a shape having a saddle point.

FIG. 2a illustrates a top view of a sheet comprising a prior art Miura folding pattern, when the sheet is in an unfolded state.

FIG. 2b illustrates a partly folded sheet comprising a prior art Miura folding pattern.

FIG. 2c illustrates an almost completely flat folded sheet comprising a prior art Miura folding pattern.

FIG. 3a illustrates a top view of a part of a fibre-containing continuous sheet according to one exemplifying embodiment of the present invention, the sheet being in an unfolded state.

FIG. 3b schematically illustrates a top view of a part of the fibre-containing continuous sheet of FIG. 3a showing one extreme of the obtainable α-angle if folded.

FIG. 3c schematically illustrates a top view of a part of the fibre-containing continuous sheet of FIG. 3a showing another extreme of the obtainable α-angle if folded.

FIG. 4 illustrates a perspective view of a partly folded sheet according to the present invention which has been slightly twisted.

FIG. 5a illustrates a top view of a part of a fibre-containing continuous sheet according to another exemplifying embodiment of the present invention, the sheet being in an unfolded state.

FIG. 5b schematically illustrates one extreme of the α-angle obtainable in the sheet according to FIG. 5a if the sheet is folded.

FIG. 5c schematically illustrates another extreme of the α-angle obtainable in the sheet according to FIG. 5a if the sheet is folded.

FIG. 6 illustrates a top view of a part of a fibre-containing continuous sheet according to yet another embodiment of the present invention, the sheet being in an unfolded state.

FIG. 7 illustrates a perspective view of a paperboard according to the present invention comprising a partly folded sheet interposed between a first and a second liner on each respective side of the partly folded sheet.

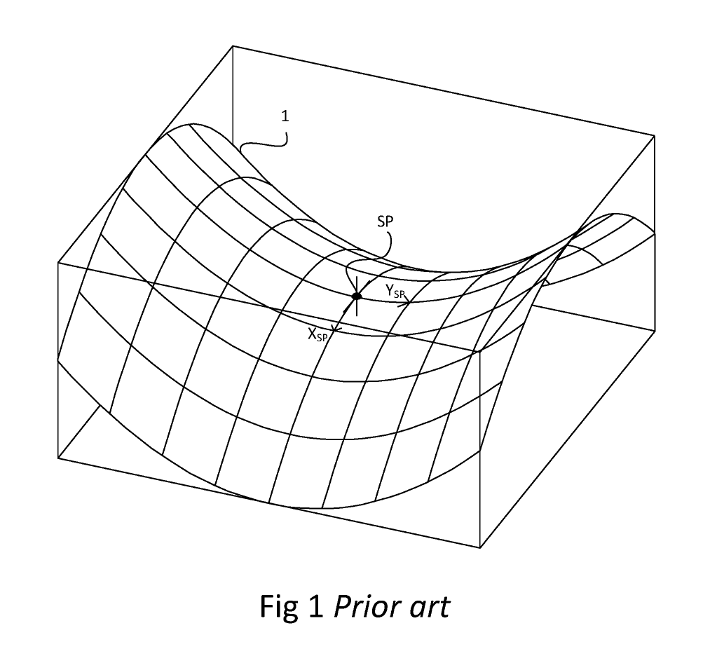

### DETAILED DESCRIPTION

In the following, the present invention will be described in more detail with reference to certain embodiments and the drawings. These do however not limit the scope of the present invention and are to be considered for illustrative purposes only. The invention may be varied within the scope of the appended claims.

Furthermore, the drawings shall not be considered to be drawn to scale since some features may be exaggerated in order to more clearly illustrate the present invention.

In the present disclosure, the term “parallelogrammic” shall be interpreted as essentially a parallelogram, and thus encompasses both a true parallelogram as well as a flat shape which in most part constitutes a parallelogram but may comprise slight deviations, such as rounded corners or the like. A true parallelogram is a flat shape comprising straight sides wherein opposite sides are parallel, opposite sides are equal in length and opposite angles are equal.

Furthermore, in the present disclosure a “facet” shall be considered to constitute an essentially flat surface with defined boundaries/edges.

It is common general knowledge that folding is a way of bending a sheet material. The act of folding deforms the sheet along a line of folding and creates a crease or the like. The deformation in the line of folding is what allows the bending to take place. To create the creases, for example blunt knives may be used to crease the material. Also, pre-folding with the purpose of creating creases may be used to aid later folding. The art of folding is well known to the skilled person and will therefore not be described in further detail except where details thereof might be relevant for the present invention.

There are several ways to test and evaluate a fibre-containing sheet. For example, tensile testing may be used to evaluate the properties of a sheet. Tensile testing is performed in-plane of a sample sheet. From the obtained stress-strain curve, the Young's modulus (hereinafter E-modulus), the tensile strength, the yield strength, elastic elongation, and the elongation to break can be determined. The bending stiffness, K, of a sheet may be expressed in accordance with Equation 1, wherein E is the E-modulus and I is a geometrical parameter.

K=E×I (Eq. 1)

For example, for a homogenous sheet the geometrical parameter I is given according to Equation 2, wherein w is the width of the sheet and h is the thickness of the sheet.

I= 1/12×w×h³ (Eq. 2)

Thus, it is clear that by altering the E-modulus, the width and/or the thickness of a sheet, the bending stiffness may be altered. For the same reason, by altering one or more of the above parameters in only a part of the sheet, the bending stiffness in such a part can be altered.

It is previously known that a folding pattern or the like may be used in order to influence the geometrical shape a sheet may obtain without disrupting or tearing the sheet. For example, it is previously known to provide a corrugated pattern on a sheet such as to influence the bending possibilities in different directions, enabling bending of the sheet in one direction while substantially avoiding bending in a perpendicular direction.

One particular example of a way of folding is Miura fold, also known as Miura folding pattern. Miura fold is a form of so called rigid origami wherein folding and unfolding can be performed in a continuous motion between the states of a flat unfolded surface and a completely flat-folded shape. It is based on fold lines formed in a pattern such that a grid of parallelograms is formed between the fold lines. The parallelograms constitute facets. During folding each facet remain flat.

Miura folding patterns are used in a wide range of application and materials to pack flat sheets into a smaller space. For example, it is used for solar panel arrays, foldable maps, and foldable membranes. It has also been previously proposed to replace honeycomb structures with Miura folds for impact absorbing crash boxes. Miura fold may be used to fold surfaces made of rigid material.

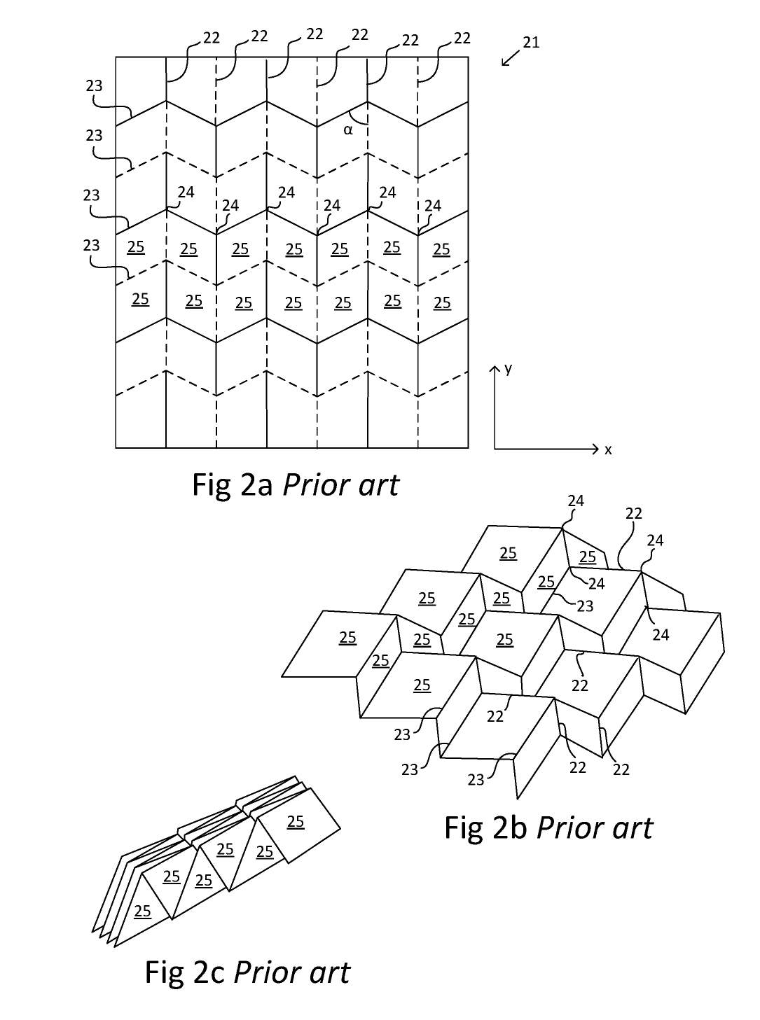

A sheet 21 comprising a classic Miura folding pattern is shown in FIG. 2a. The pattern consists of a series of parallel straight fold lines 22 in a first surface direction y. The straight fold lines are intersected by zigzag fold lines 23 in a second surface direction x. Each zigzag fold line alters course at each and every intersection 24 with a straight fold line 22. The straight fold lines 22 and zigzag fold lines 23 together define a grid of facets 25, wherein each facet has the form of a parallelogram. In the classic Miura folding pattern, the zigzag lines are parallel to each other as shown in FIG. 2a. The acute angle formed by the intersection of the zigzag fold lines and the straight fold lines is commonly known as the α-angle. The α-angle of a classic Miura folding pattern may typically vary within the range of from 55 to 85°.

Upon folding the Miura folding pattern, a series of mountain folds and valley folds are formed. In FIG. 2a, the parts of the folding lines which are to be folded to mountain folds are drawn as full lines whereas the folding lines which are to be folded to valley folds are drawn as dashed lines. Thus, it can be seen from the figure that each zigzag fold line is adapted to be fold solely to a mountain fold or solely to a valley fold, with mountain folds alternating with valley folds form one zigzag fold line to the subsequent zigzag fold line. Each of the straight fold lines 22 is adapted to fold to alternating valley folds and mountain folds in correlation with each intersection 24 with a zigzag fold line 23. FIG. 2b illustrates a partly folded sheet comprising a classic Miura folding pattern, for example the one shown in FIG. 2a. The facets 25 in the form of parallelograms remain flat during folding and unfolding, i.e. the folding or unfolding process can be carried out in a continuous motion during which the parallelograms remain completely flat at all times and the folding is only effectuated in the fold lines 22, 23. The folding angle θ (not shown) is the angle between the facets and the xy-plane. In unfolded state, the folding angle is 0°, and when flat folded, the folding angle θ is 90°. A completely folded Miura fold can be packed into a very compact shape which is essentially limited only by the thickness of the sheet. FIG. 2c illustrates an example of an almost completely flat-folded sheet comprising a classic Miura folding pattern. In the example shown, flat folding has been made in one direction only, i.e. by moving two opposing surface edges of the sheet towards each other in one direction while not actively moving the other two opposing surface edges of the sheet towards each other. It is however also possible, depending on the parameters of the folding pattern in terms of angles and dimensions of the facets, to flat fold in two perpendicular directions simultaneously. One way of doing so is execute the folding by moving two opposing corners of the sheet towards each other.

The classic Miura folding pattern can be modified in various ways such as to enable obtaining other geometrical shapes than completely flat when folded. For example, Gattas et al., Miura-Base Rigid Origami: Parameterizations of First-level Derivative and Piecewise Geometries, Journal of Mechanical Design, vol. 135, p. 111011-1-111011-11, November 2013, discloses simulations of folding patterns derived from a Miura based folding pattern, and shows how various complex piecewise geometries can be achieved.

As in any folding pattern, a folding line of a classic Miura folding pattern has a lower bending stiffness than the sheet as such. The lower bending stiffness of the fold lines may be achieved in various ways depending on the material of the sheet comprising the Miura folding pattern. For example, the folding line may be a crease line, an otherwise pressed line, a perforated line or a pre-folded line. A folding line will always have a breadth, which depends on how the folding line has been formed, for example on the tool used to form the folding line.

Examples of apparatuses known for obtaining a Miura fold are disclosed for example in WO 2004/078627 A1 and JP 2002-036398 A. It is also known (however for other folding patterns) for example to print folding lines on a sheet in case of sheets consisting of synthetic polymer fibres (see “Applied Origami”, Ingenia, Issue 61, December 2014, p. 32-37) or pressing for example water on a paper to create folding lines (see for example Creative Applications Network, Visnjic, F., “Hydro-Fold by Christopher Guberan—Self folding inkjet printed paper”, CreativeApplications.Net, published 15 Apr. 2012, retrieved from the Internet on 25 Sep. 2015, http://www.creativeapplications.net/other/hydro-fold-by-christophe-guberan-self-folding-inkiet-printed-paper/).

The present invention is based on a classic Miura folding pattern, but the folding pattern of the substantially planar sheet is modified in order to increase the degree of freedom when folding to enable more complex geometrical shapes of a partly folded sheet. This is achieved by utilizing different breadths of the straight folding lines compared to the zigzag folding lines as seen in-plane of the continuous fibre-containing sheet, i.e. the xy-plane. More specifically, the breadth of the zigzag fold lines is greater than the breadth of the straight fold lines. The purpose of such a modification of the folding pattern is to enable the α-angle to adopt different values, i.e. enable a degree of freedom of the α-angle during folding or during subsequent forming of a partly folded sheet into a three dimensional complex form of a product. In other words, during folding of the continuous fibre-containing sheet or subsequent shaping of a partly folded sheet obtained thereof, the α-angle is not limited to the α-angle defined by the folding pattern of the continuous fibre-containing sheet as such when in flat unfolded state, i.e. the acute angle defined by the straight fold lines and the zigzag fold lines where they intersect when the continuous fibre-containing sheet is in a flat unfolded state. The fact that the bending stiffness in the fold line is lower than the bending stiffness of the facets enables the possibility of the α-angle to vary since the actual folding line is only limited by the outer boundaries of a fold line along its course.

As mentioned above, any folding line will always have a breadth. Depending on the processes used to manufacture the sheet according to the present invention, as will be described further below, the sheet may have different thicknesses in the part constituting the fold lines and in the part constituting the facets, whereby the fold lines can be easily determined and the breadth thereof measured. Depending also on the conversion technique(s) used to obtain a sheet comprising the folding pattern, the folding lines and the facets may have a visually different appearance whereby it is easy to determine which part of the sheet constitutes the part constituting the fold lines and which part constitutes the part constituting the facets, and thereby measure the breadth of a folding line.

However, in instances where the thickness and/or the visual appearance of the sheet is the same in the part constituting the folding lines and in the part constituting the facets, it may be necessary to determine the breadth of a fold line by executing folding such that two facets arranged on opposite sides of the fold line are essentially parallel, and thereafter determine the breadth defined by the boundaries of a fold line at the outer curvature thereof and along its course. The boundaries of a fold line are in such a case defined by the opposing respective points where the outer curvature of the fold line becomes tangent to the facet surface immediately adjacent to the fold line. The outer curvature is the curvature on the outer surface when the sheet has been completely folded in a fold line such that the adjacent facets arranged on opposite sides of the fold line are essentially parallel.

The fibre-containing sheet according to the present invention is preferably a continuous sheet, which in the present disclosure is considered to mean a sheet which is in one piece without any intentional interruptions such as slits or the like adapted to widen when the sheet is deformed such as to enable shaping the sheet or partly folded sheet product to the intended geometrical shape. In other words, the fibre-containing sheet according to the present invention is not dependent on the presence of slits or the like, adapted to widen during bending, in order to be able to be bent to the desired geometrical shape. However, the above definition shall not be considered to exclude holes or other openings which are provided for esthetical purposes or the like. Moreover, the above definition does not exclude a sheet comprising perforations or the like in the fold lines in order to decrease the bending stiffness of the fold lines. A continuous fibre-containing sheet according to the present invention may consist of only one fibre-based layer but may also consist of a plurality of stacked fibre-based layers.

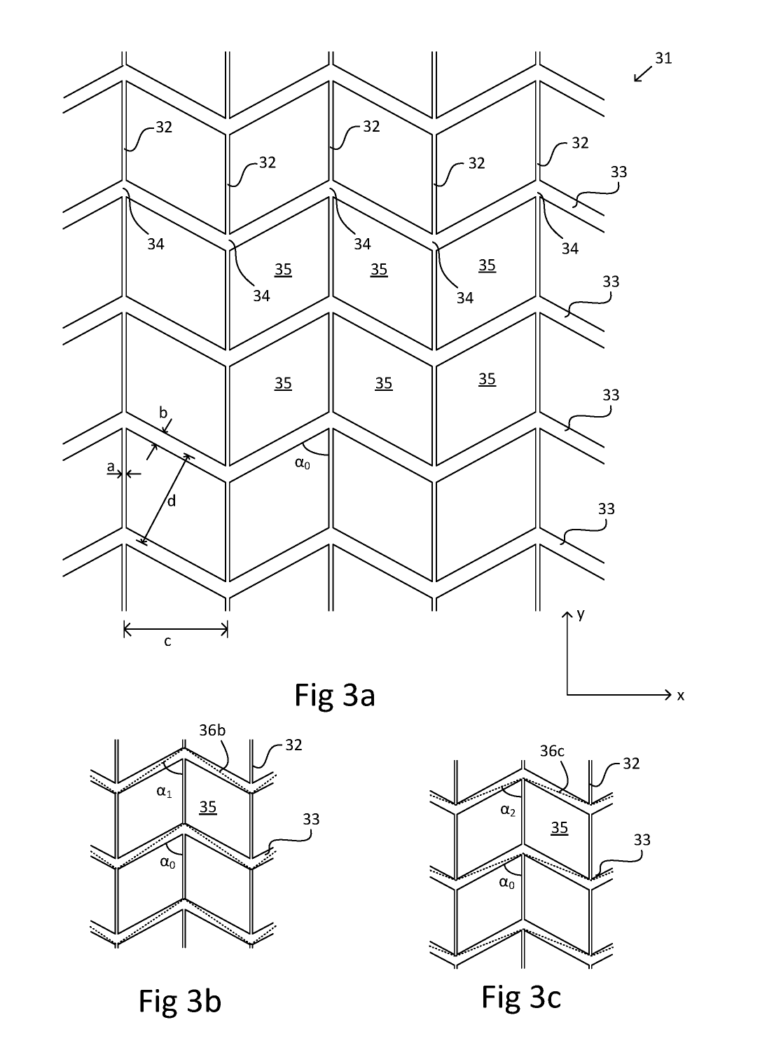

FIG. 3a illustrates one exemplifying embodiment of a part of a flat, unfolded, fibre-containing continuous sheet 31 in accordance with the present invention comprising a folding pattern. The folding pattern comprises a series of parallel straight fold lines 32 extending in a first surface direction y of the fibre-containing continuous sheet 31. The folding pattern further comprises a series of zigzag fold lines 33 extending in a second surface direction x of the fibre-containing continuous sheet. The straight fold lines 32 are intersected by the zigzag fold lines 33, and each zigzag fold line alters course at each and every intersection 34 with a straight fold line 32. Thus, the straight fold lines 32 and the zigzag fold lines 33 together define a grid of facets 35. Each facet 35 is defined by a part of two subsequent parallel straight fold lines and a part of two subsequent zigzag fold lines, and wherein each corner of the facet 35 is defined by an intersection 34 of a straight fold line and a zigzag fold line. Thereby, each facet 35 is parallelogrammic in shape in the plane of the fibre-containing continuous sheet. The parallelogrammic shape is defined by the parameters of length distances between the folding lines and the acute angle between the folding lines at the intersection thereof, also known as the α-angle. In FIG. 3a, the α-angle when the sheet is in a flat unfolded state is denominated α₀.

As shown in FIG. 3a, each zigzag fold line has a breadth b, measured perpendicular to the course of the zigzag fold line in every specific point, which is greater than the breadth a of any one of the parallel straight fold lines 32, the breadth a measured perpendicular to the course of the straight fold line. In other words, the zigzag fold lines are thicker than any one of the straight fold lines.

Compared to a classic Miura folding pattern, the folding pattern according to the present invention therefore comprises thicker zigzag fold lines than necessary for folding the sheet into a flat-folded sheet product. The straight fold lines may have a breadth just enough for enabling the sheet to be folded into a flat folded sheet product without causing tearing, cracking or breakage in the fold line, or may have a slightly greater breadth than necessary therefore. It is also plausible, in cases where a flat folded sheet product is not necessary, to have a breadth which is just enough to obtain the desired fold without risking tearing, cracking or breakage of the sheet in the fold line during folding.

When folding the fibre-containing continuous sheet comprising the folding pattern according to the present invention, the facets are intended to remain flat such that no deformation occurs in the facets. Thereby, like in a classic Miura folding pattern, the folding motion is limited to the folding lines and folding can be performed in a continuous motion to a completely flat folded state. However, compared to a classic Miura folding pattern, the folding pattern according to the present invention enables a greater flexibility during folding as a result of the zigzag fold line having a greater breadth than the straight fold lines.

More specifically, the fact that the zigzag fold lines have a greater breadth than the straight fold lines results in a sheet wherein the α-angle, during folding and/or subsequent forming of a partly folded sheet thereof, is not limited to the α₀-angle defined by the folding pattern as such when the fibre-containing continuous sheet is in the flat unfolded state. Instead, the α-angle may change. Since the sheet has a lower bending stiffness in the part constituting the fold lines compared to the part constituting the facets, the actual α-angle can vary within the boundaries defined by a respective folding line, i.e. the edges of a folding line defining its breadth. This is illustrated in FIGS. 3b and 3c, wherein the minimum α-angle α₁ and maximum α-angle α₂ obtainable during folding and/or subsequent shaping of a partly folded sheet are shown respectively. For sake of clarity, the fibre-containing continuous in FIGS. 3b and 3c is shown in the flat unfolded state whereas the minimum α-angle α₁ and maximum α-angle α₂ are the ones which could be obtained during folding of the continuous fibre-containing sheet. The α-angle defined by the folding pattern as such, i.e. the α-angle when the sheet is in a flat unfolded state is denominated α₀. In FIGS. 3b and 3c, the obtainable actual folding lines 36b and 36c, respectively, within the zigzag folding lines are illustrated with dashed lines for sake of clarity.

While not illustrated in the figures, the fact that the α-angle may change in the sheet according to the present invention during folding or subsequent shaping of the partly folded sheet also enables different α-angles in different parts of the partly folded sheet such as to enable shaping the partly folded sheet to more complex geometrical forms.

As shown in FIG. 3a, all straight lines 32 suitably have a uniform breadth a, and all zigzag fold line suitably have a uniform breadth b. That is, the breadth of each fold line is constant. Each of the straight fold lines may have the same breadth, and/or each of the zigzag fold lines may have the same breadth. It is however for example also plausible that two subsequent zigzag fold lines have different breadths, as long as these breadths are greater than the breadth of any straight fold line.

The breadth b of a zigzag fold line may suitably be at least twice that of breadth a of the straight fold line. Preferably, the ratio of the breadth b of a zigzag fold line to the breadth a of a straight fold line may be from 2.5:1 to 5:1.

The minimum breadth of the straight fold lines depends on the thickness of the sheet as well as the material of the sheet, i.e. the breadth needed to enable complete full folding (or at least folding to the intended folding angle) in the folding line. The minimum breadth of the straight fold line can easily be determined by a skilled person by trial and error depending on the sheet used. The maximum breadth of a straight fold line may for example be selected such as to minimize any deflection in the fold line during folding. The reason for this is that it is desired that the straight fold lines remain parallel even after folding. Therefore, the breadth of a straight fold line is preferably selected such as to not influence the α-angle during folding and/or subsequent shaping of the partly folded sheet. If the straight fold lines have a too large breadth, a partly folded sheet product obtained from the continuous sheet product may become difficult to handle in terms of stability and therefore be difficult to shape into a final intended geometrical shape.

The distance between any two subsequent parallel straight fold lines c and a distance between any two subsequent zigzag fold lines d may suitably be within a ratio of from 1:5 to 5:1, preferably within a ratio of from 1:2 to 2:1, more preferably within a ratio of from 1:1.5 to 1:1. As shown in FIG. 3a, the distance between two fold lines is measured perpendicular to the course of the fold line and centre-to-centre of the fold lines. In the exemplifying embodiment shown in FIG. 3a, the distance c between any two subsequent straight fold lines is uniform. Furthermore, the distance d between any two subsequent zigzag fold lines 33 is uniform.

The ratio of the distance between any two subsequent two zigzag fold lines d and the breadth of each zigzag fold line b may for example be from 2:1 to 10:1, preferably from 2.5:1 to 7:1. Thereby, it is ensured that the facets have a suitable size compared to the breadth of the zigzag folding lines. If the zigzag folding lines have a too large breadth, it will be difficult to control the α-angle during folding. Furthermore, if the facets are too small in comparison to the breadth of the fold lines, a partly folded sheet product obtained from the continuous fibre-containing sheet may become difficult to handle since it may be too flexible. This can in turn lead to an inferior stability of the sheet product, and if used as a flute in a laminate or cardboard to an inferior rigidity of the flute.

The acute angle formed by the intersection of the zigzag fold lines and the parallel straight fold lines when the sheet is in the flat unfolded state, in FIG. 3a illustrated as α₀, may for example be from 50° to 85°, preferably from 55° to 75°.

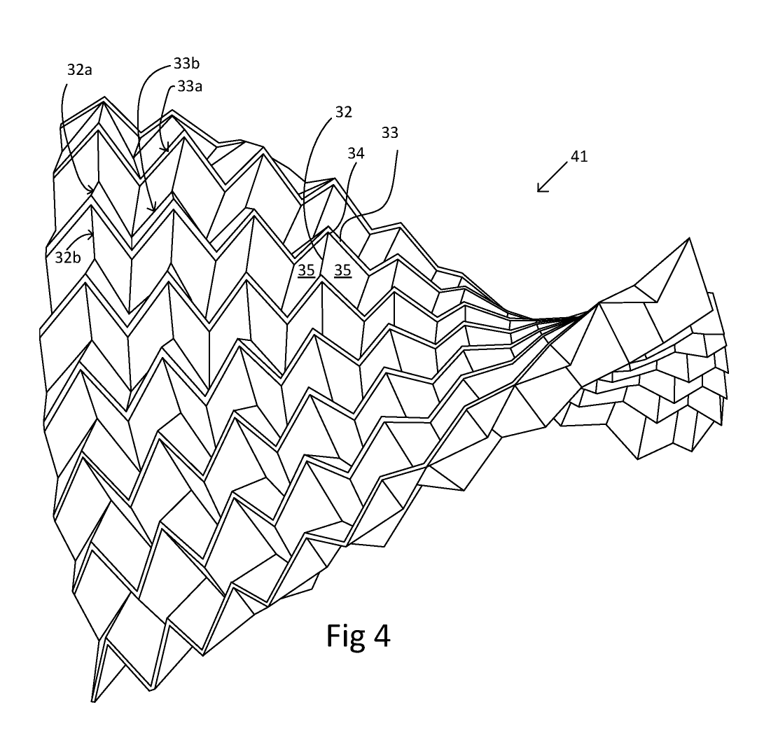

FIG. 4 illustrates an example of a partly folded sheet 41 obtained by folding the flat unfolded sheet comprising the folding pattern as illustrated in FIG. 3a. In FIG. 4, the partly folded sheet has been somewhat twisted to an intended geometrical shape. As can be seen in FIG. 4, each zigzag fold line 33 is in the form of a mountain fold 33a or in the form of a valley fold 33b. In contrast, each straight fold lines 32 will be divided into alternating mountain folds 32a and valley folds 32b at each intersection 34. Each facet 35 remains flat despite the folding of the sheet and subsequent shaping of the partly folded sheet into the intended geometrical form.

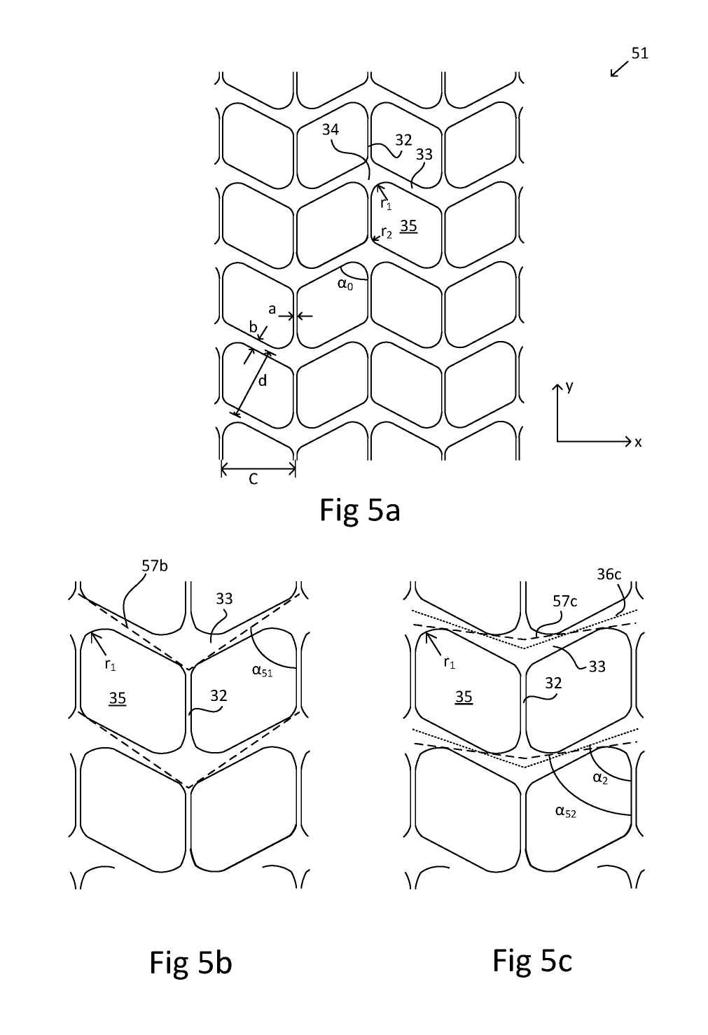

FIG. 5a illustrates another exemplifying embodiment of a sheet 51 comprising a folding pattern according to the present invention similar to the sheet 31 shown in FIG. 3a. However, in contrast to the folding pattern as shown in FIG. 3a, the facets according the folding pattern shown in FIG. 5 are not strict parallelograms. While parallelogrammic in shape, the facets comprise rounded corners at least at where the folding lines intersect to form an acute angle, i.e. the α₀-angle. In FIG. 5, the corners defining an acute angle have a rounded corner with a radius r₁ and the corners defining an obtuse angle have a rounded corner with a radius r₂. The ratio between the radius r₁ and the breadth b of a zigzag fold line may for example be from 1:4 to 1:1, preferably from 1:2.5 to 1:1. The radiuses r₁ and r₂ may be equal or differ from each other. According to one exemplifying embodiment, r₁ is greater than r₂.

It has been found that when the facets comprises rounded corners, such as shown in FIG. 5a, there is an even greater flexibility in change of α-angle during folding and/or subsequent forming of the partly folded sheet. In fact, it has been found to be possible to obtain α-angles of about 90°. Thus, providing the facets with rounded corners, the rounding constituting a part of the fold lines, enhances the ability to form the partly folded sheet into various complex geometrical shapes. It also enhances the possibilities of completely flat folding in each of the two perpendicular directions of the sheet.

This is further illustrated in FIGS. 5b and 5c, corresponding to the folding pattern shown in FIG. 5a, and wherein the extremes of the α-angle are shown. FIG. 5b illustrates the obtainable actual folding line 57b within a zigzag fold line resulting in an α-angle illustrated as α₅₁. Compared to the case where the corners of the facets are not rounded as illustrated in FIG. 3b, the obtainable actual folding line 57b corresponds to the obtainable actual folding line 36b and hence the angle α₅₁ is equal to α₁. FIG. 5c illustrates the other extreme, i.e. the obtainable actual folding line 57c resulting in an α-angle illustrated as α₅₂. For sake of comparison, the actual obtainable folding line 36c in case of no rounded corners, such as illustrated in FIG. 3c, is also shown. It is clearly shown that α₅₂ is greater than α₂ obtainable where the facets have no rounded corners.

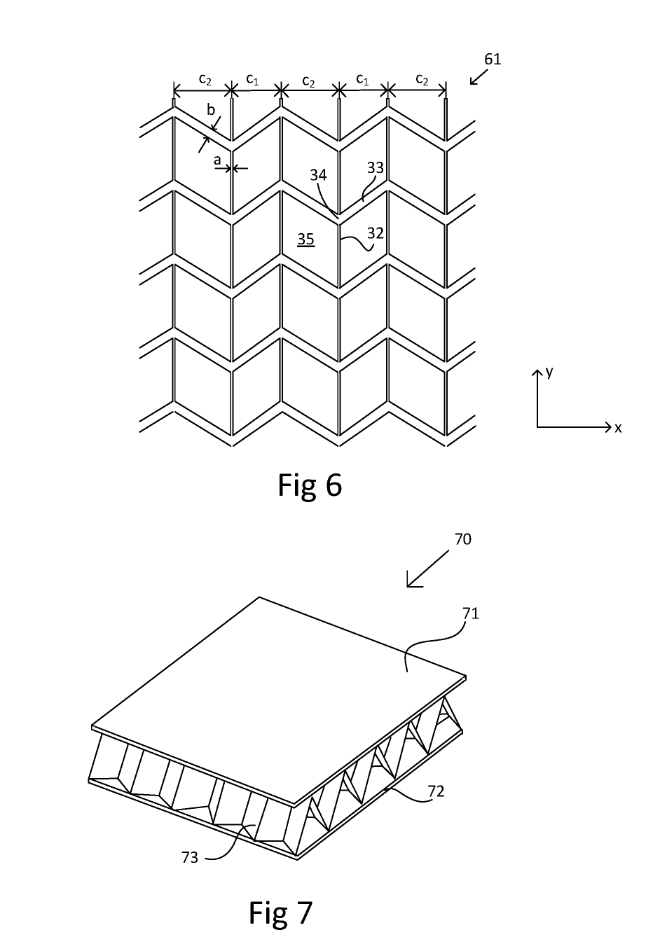

Another exemplifying embodiment of a sheet 61 comprising a folding pattern according to the present invention is shown in FIG. 6. Compared to the sheet 31 comprising a folding pattern as shown in FIG. 3a, the parallel straight folding lines are not provided at equal distances from each other. A distance c₁ between a first and a subsequent second straight folding line is smaller than the distance c₂ between the second straight folding line and a subsequent third folding line, the distances c₁ and c₂ thus alternating in the second surface direction of the sheet. By means of such an exemplifying embodiment, when the sheet is partly folded, it is possible to obtain different folding angles of the facets in two adjacent rows of facets, a row of facet in this context constituting a row seen in the first surface direction. Thereby, the different rows of facets will during folding obtain different slopes (orientations in relation to the original xy-plane). By way of example only, one row of facets seen in the first surface direction of the continuous fibre-containing sheet may obtain a folding angle of about 90°, whereas an adjacent row of facets may obtain a folding angle of about 45-70°.

The exemplifying embodiment wherein the distances c₁ and c₂ are different from each other may be especially suitable in applications wherein the partly folded sheet product constitutes a flute in a laminate or cardboard and wherein a high impact resistance of such a laminate or cardboard is desired. For example, such a partly folded sheet product may be highly suitable to replace a honeycomb flute.

While not illustrated in FIG. 6, it should be noted that the facets in this exemplifying embodiment may also comprise rounded corners as disclosed in the exemplifying embodiment disclosed with reference to FIG. 5a.

A partly folded sheet in accordance with the present invention may suitably be utilized for example in cardboard, such as to replace a corrugated layer, a honeycomb layer or the like. One exemplifying embodiment of a cardboard according to the present invention is illustrated in FIG. 7. The cardboard 70 comprises a first liner 71 and a second liner 72. The liners may for example also be made of fibre-containing sheets with the same or different composition as the partly folded sheet. A partly folded sheet, folded from any one of the above described sheets comprising a folding pattern, is interposed between the first and the second liner. While not illustrated in the figure, the cardboard may comprise further layers of liners and/or of a partly folded sheet.

While not illustrated in the drawings, the partly folded sheet may also be used as a layer in other types of laminates. For example, a partly folded sheet according to any of the embodiments disclosed above may be laminated to a liner made of polymer-based materials or the like.

The present invention is not solely based on the specific folding pattern but also on the material of the fibre-containing sheet comprising the folding pattern. The sheet comprising a folding pattern according to the present invention comprises fibres and optionally additional constituents as will be described further below. The fibres are preferably produced from renewable resources for environmental purposes. More specifically, the sheet according to the present invention preferably comprises cellulose fibres.

Cellulose fibres as used herein refers to fibrous material generally derived from, but not limited to, natural resources, such as annual plants or wood. The chemical composition as well as the geometrical configuration of the cellulose fibres will depend on the raw material used to derive the cellulose fibres as well on the extraction procedure used, i.e. the resulting pulp.

The invention is not particularly limited to any specific type of cellulose fibres used and the cellulose fibres may therefore be selected depending for example of the intended use of the sheet comprising the folding pattern. Examples of suitable cellulose fibres are bleached or unbleached sulphate fibres, bleached or unbleached sulphite fibres, thermomechanical pulp (TMP) fibres, chemo-thermomechanical pulp (CTMP) fibres, nanofibrillated cellulose (NFC) and microfibrillated cellulose (MFC). However, any other fibre extracted from wood or annual plants using an industrial or industrial-like process may also be used. The cellulose fibres may also constitute, partly or exclusively, regenerated cellulose. A skilled person may select any type of cellulose fibres depending on the intended use of the sheet in final applications, such as packaging material for various purposes.

According to an exemplifying embodiment of the present invention, the sheet comprises cellulose and at least one selected from polylactide (PLA), polyhydroxyalkanate (PHA), caprolactam (CPL) and thermoplastic starch (TPS). Cellulose is in the form of fibres whereas PLA, PHA, CPL and TPS may be present in either particulate form or in fibre form. Preferably, the sheet comprises cellulose fibres and PLA fibres or particulates, preferably PLA-fibres.

As previously disclosed, polylactide (PLA) is a biodegradable thermoplastic aliphatic polyester derived from renewal sources. Polyhydroxyalkanate (PHA) is a biocompatible linear polyester obtainable for example from sugar or glucose by bacterial fermentation. Caprolactam has the general formula (CH₂)₅C(O)NH and may for example be obtained by synthesis from cyclohexanone. Thermoplastic starch (TPS) may be produced by modifying starch to obtain thermoplastic properties, and thus renewable and biodegradable.

The fibre-containing sheet may also comprise additional additives as desired, for example depending on the intended use of the sheet. Examples of such additives comprise, but are not limited to, fillers, colouring agents, softeners, stiffening additives and binders.

The constituents of the fibre-containing sheet may suitably be mixed such as to provide a homogenous compositional distribution throughout the sheet, i.e. the part of the sheet constituting the folding lines and the part of the sheet constituting the facets may be made of the same composition. However, as will be further disclosed below, it is also plausible that the sheet has different compositions in the part constituting the fold lines and in the part of sheet constituting the facets as a result of how the facet are stiffened if such a step is taken.

As mentioned above, when present, each of the polylactide, the polyhydroxyalkanate, the caprolactam and the thermoplastic starch may be in the form of fibres or particulates. In case the at least one selected from polylactide, polyhydroxyalkanate, caprolactam and thermoplastic starch is in the form of fibres, it may give the sheet more flexible (textile-like) properties compared to for example a sheet essentially consisting of cellulose fibres (such as conventional paper).

It is previously known that composites comprising cellulose fibres and PLA-fibres may possess textile-like properties. Such composites may for example comprise about 5-40% by weight of PLA, the balance essentially consisting of cellulose fibres and possible additional additives as described above; or for example about 40-65% by weight of PLA, the balance essentially consisting of cellulose fibres and possible additional additives as described above. Such a material has a good stretchability in itself, for example due to weak fibre-to-fibre bonds. As previously described, when the composite material is activated, the composite changes to more plastic-like and becomes rigid and dimensionally stable. This may in certain applications be advantageous for locking the partly folded sheet into the formed geometrical shape if desired. It also has the advantage of enabling the facets to obtain a higher bending stiffness than the folding lines as will be described further below.

An alternative to a composite comprising cellulose fibres and PLA fibres or particulates, is composites comprising cellulose fibres and polyhydroxyalkanates (PHA). Such composites are for example previously known for use in food packaging. PHA can change properties from soft and elastomeric to hard as a result of application of heat, or heat and pressure. PHA may typically have a melting temperature of about 50-180° C. Such a composite may for example comprise 5-65% by dry weight of PHA and the balance cellulose fibres and possible additives as described above.

Yet another alternative is a composite comprising cellulose fibres and caprolactam (CPL). Such a composite may for example comprise up to 30% by dry weight of CPL and the balance cellulose fibres and possible additives as described above. Caprolactam is a colourless solid that is soluble in water and has a very low melting point at about 69° C. The low melting temperature makes it somewhat soft at room temperature and stiff in a cold environment.

Yet another alternative is a composite comprising cellulose fibers and thermoplastic starch (TPS). TPS are usually blends of starch with other hydrogen bonding plasticizers such as water, glycerol and sorbitol, and fillers such as cellulose, zein, natural rubber, poly vinyl alcohol, and polylactide. The thermoplastic properties (softening and melting temperature) and its mechanical properties can be tailored depending on the blend. Such a composite may for example comprise 5-65% by dry weight of TPS and the balance cellulose fibres and possible additives as described above.

In accordance with the present invention, there are three possibilities for obtaining the desired properties of the continuous fibre-containing sheet in the different parts thereof, i.e. the part constituting the fold lines and the part constituting the facets, such that the bending stiffness of the part constituting the fold lines is lower that the bending stiffness of the part constituting the facets. The first alternative is to merely reduce the bending stiffness in the part constituting the fold lines compared to the bending stiffness of the continuous fibre-containing sheet as such (i.e. the bending stiffness of the sheet before the folding pattern is formed). The second alternative is to merely increase the bending stiffness of the part constituting the facets compared to the bending stiffness of the continuous fibre-containing sheet as such (i.e. the bending stiffness of the sheet before the folding pattern is formed). The third alternative is to both reduce the bending stiffness in the part constituting the fold lines and to increase the bending stiffness in the part constituting the facets, compared to the bending stiffness of the continuous fibre-containing sheet as such before the folding pattern is formed. Altering the bending stiffness in a part of the continuous fibre-containing sheet may, as disclosed above, be made by altering the E-modulus and/or the geometrical parameters of the part (compare Equation 2). The alternatives are explained further below.

The folding lines of the sheet according to the present invention may be formed in different ways, such as by crinkling, creasing, folding or otherwise weakening of the part of the sheet constituting the folding lines. It is further plausible to perforate the part constituting the fold lines in order to change the geometrical parameter I and thereby achieve a desired bending stiffness in said part of the continuous fibre-containing sheet. However, it is also possible that the folding lines are formed merely by stiffening the facets, as described above and below, thereby inherently rendering the folding lines a lower strength than the facets.

The sheet as such may preferably have certain elasticity, at least before the folding pattern is formed, for best results. More specifically, the sheet should preferably be able to stretch in-plane of the sheet. This further aids in obtaining a desired low bending stiffness of the part of the fold lines and may for example minimize the need for additional processing steps for reducing the bending stiffness in said part of the continuous fibre-containing sheet.

In order to further ensure that the folding motion occurs in the folding lines while the facets remain flat, the part constituting the facets may according to one exemplifying embodiment suitably be stiffened in comparison to the bending stiffness of the sheet as such. In order words, it is preferred that the part of the sheet constituting the facets is subjected to a treatment or processing step in order to increase the bending stiffness thereof. The stiffening of the facets also reduces the stretchability of the material of the sheet in the parts of the sheet constituting the facets and thus facilitates the handling of the continuous fibre-containing sheet when partly folded due to increased rigidity.

In view of the above, it is realized that the sheet preferably may be subjected to processing steps resulting in, compared to a sheet produced of the same material but not comprising a folding pattern, a reduced bending stiffness in the parts constituting the folding lines and an increased bending stiffness in the parts constituting the facets. It is however also plausible that either the part constituting the folding lines is subjected to a process which reduces the bending stiffness while the part constituting the facets remain unaltered in terms of bending stiffness, or that the part constituting the folding lines is not treated and hence remain unaltered in terms of bending stiffness, whereas the facets are stiffened.

Stiffening of the part of the sheet constituting the facets may be achieved in different ways. For example, stiffening may be achieved by applying a coating layer onto the part of the sheet constituting the facets. Applying a coating can be performed by any previously known methods, such as by roller coating, printing or the like. Examples of suitable materials for such a coating of the facets include for example starches (including thermoplastic starches), waxes, nanofibrillated cellulose (NFC), cellulose fines, lacquers, or other chemicals.

It is also possible to stiffen the part of the sheet constituting the facets by impregnating or soaking the part of the sheet constituting the facets with a stiffening agent. Suitable stiffening agents may be the same as mentioned above as suitably coating materials and thus includes for example starches (including thermoplastic starches), waxes, nanofibrillated cellulose (NFC), cellulose fines, lacquers, or other chemicals. The difference between a coating material and a stiffening agent thus resides in where the coating material/stiffening agent will be arranged after addition, i.e. on the surface or within the bulk of the part of the sheet constituting the facets. The stiffening agent may for example act by merely increasing the density of the sheet in the part constituting the facets and thereby increasing the bending stiffness thereof, or may be allowed to harden or the like such as to increase the bending stiffness in the part constituting the facets. Impregnating the parts constituting the facets may be achieved by any known method, such as printing methods. Examples of such printing methods includes screen printing, flexographic printing, offset printing, tampon printing, gravure printing, spot coating, or digital non-impact printing methods such as ink jet printing. According to one exemplifying embodiment, the part of the sheet constituting the facets is impregnated with a solution comprising a solvent and at least one selected from polylactide, polyhydroxyalkanate, caprolactam and thermoplastic starch.

Stiffening of the part of the sheet constituting the facets may also be, depending on the material used, achieved by welding, hardening or thermopressing. Welding, hardening or thermopressing are suitable in cases where the sheet comprises a constituent which is able to obtain a higher strength if subjected to heat, or heat and pressure. Such a constituent may for example be a thermoplastic polymer, including the aforementioned polylactide, polyhydroxyalkanate, caprolactam and thermoplastic starch. Welding, hardening or thermopressing may be performed according to any previously known method including, but not limited to, electron beam curing, electrical resistance curing, ultrasound welding, infrared illumination welding, compression moulding, vacuum moulding, inductive heating, microwave curing, and UV curing. It is also for example possible to slightly heat the sheet to a temperature below the melting temperature of each of the constituents of the sheet and apply pressure on the part of the sheets constituting the facets such that at least one of the constituents melt, and only in the part of the sheet constituting the facets, as a result of the heat and pressure.

By way of example, in case the fibre-containing sheet comprises cellulose fibres and at least one selected from polylactide, polyhydroxyalkanate, caprolactam and thermoplastic starch (irrespective of being homogenously distributed within the sheet or only impregnated into the parts of the sheet constituting the facets), the parts of the sheet constituting the facets are suitably stiffened by being subjected to heat, or more preferably heat and pressure, such as to at least partly melt the at least one of polylactide, polyhydroxyalkanate, caprolactam and thermoplastic starch. Thereby, the at least one of polylactide, polyhydroxyalkanate, caprolactam and thermoplastic starch will obtain a higher strength and consequently give part of the sheet constituting the facets a higher bending stiffness.

As previously mentioned, the continuous fibre-containing sheet according to the present invention may suitably be quite flexible and stretchable at least before the folding pattern is formed. This ensures that the folding lines remain flexible even after the sheet has been folded. More specifically, it facilitates the degree of freedom of the α-angle during folding or subsequent shaping of a partly folded sheet in the zigzag folding lines. It is therefore desired to select the constituents of the sheet such that its composition makes it quite flexible and stretchable.

For the same reason, the sheet may be subjected to further processing steps in order to make the sheet more flexible and/or stretchable. One particularly suitable alternative is creping. Any previously known creping process may be used without departing from the scope of the present disclosure. Creping is a process wherein a sheet is provided with densely distributed small wrinkles/undulations/compactions and is frequently used in the field of paper converting. It can be made by doctoring (using a creping blade) a moist fibre containing web from a supporting cylinder. An alternative is dry creping wherein the web is substantially dry (for example having moisture content of about 5-10%). Creping can increase the elongation or stretch, usually to well above 20%, often above 100%, and in some cases even up to more than 500%, of a corresponding non-creped sheet. Preferably, the creping may suitably be made to provide wrinkles or undulations of a size in the range of microns, so called micro-creping. It is also plausible to perform creping such as to provide wrinkles or undulations of a size in the range of millimetres. Creping of the sheet may suitably be made before the sheet is provided with the folding pattern. Alternatively, creping may be made after the folding pattern has been formed but prior to the stiffening of the part of the sheet constituting the facets.

In case the part constituting the facets has been stiffened as disclosed above, said part of the sheet will despite a process such as creping, have a substantially higher bending stiffness than the folding lines. In fact, the part constituting the facets may be essentially rigid.

The present invention further relates to a method of producing a fibre-containing sheet comprising a folding pattern, such as a sheet according to any of the exemplifying embodiments disclosed above. The method comprises the steps of providing a fibre-containing continuous sheet and forming a folding pattern on said sheet such that the folding pattern comprises a series of parallel straight fold lines in a first surface direction of the sheet, the straight fold lines being intersected by zigzag fold lines extending in a second surface direction of the sheet, each zigzag fold line altering course at each and every intersection with a straight fold line, the straight fold lines and zigzag fold lines together defining a grid of facets, wherein each facet is parallelogrammatic in form, and wherein each zigzag fold line has a breadth b that is greater than a breadth a of any one of the parallel straight fold lines, wherein fold line breadth is measured perpendicular to the course of the fold line.

The method may further comprise stiffening a first part of the sheet constituting the facets in relation to a second part of the sheet constituting the fold lines.

The sheet obtained may subsequently be at least partly folded along the fold lines in order to form mountain folds and valley folds. Each zigzag fold line consists solely of a mountain fold or of a valley fold, with mountain folds alternating with valley folds from one zigzag fold line to the subsequent zigzag fold line. Each of the straight fold lines alternates between valley folds and mountain folds in correlation with each intersection with a zigzag fold line.

The method may further comprise creping the sheet prior to forming the folding pattern or after forming the folding pattern but prior to stiffening of the part constituting the facets.

The fibre-containing continuous sheet according to the present invention can be used either alone for various purposes such as packaging material or the like. It is also possible to use the fibre-containing continuous sheet, when partly folded, as a flute in cardboard or the like further comprising at least one liner arranged on one side of the flute. The liner may be made of a textile-like material or of a paper-like material as desired depending on the intended application. The fibre-containing sheet may also be used in other applications such as in building elements or in interior design.

If using a flexible liner on either side of a partly folded sheet product according to the present invention, it is possible to obtain a structure, similar to a corrugated cardboard, which can be shaped into various complex geometrical shapes such as saddle points. If such a structure, after having been formed to the intended geometrical shape is subjected to a process causing the liner(s) to stiffen, the geometrical shape can be locked in place. Thereby, it is possible to obtain substantially rigid structures having complex geometrical shapes and at the same time being of low weight.

### Example 1

Two continuous fibre-containing sheets were produced of a pulp consisting of commingled 40% by dry weight of bleached sulphate pulp and 60% by dry weight of PLA fibres. The thickness of the continuous fibre-containing sheets was about 0.7 mm and the grammage was 110 g/m². One of the sheets was subjected to creping, whereas the other sheet not creped. The creped sheet has an E-modulus of about 0.01 GPa whereas the non-creped sheet had an E-modulus of about 0.6 GPa.

The continuous fibre-containing sheets were provided with a folding pattern in accordance with the exemplifying embodiment as illustrated in FIG. 5a by stiffening the part constituting the facets using a 3D-printing head so as to activate the PLA. Based on previous tests wherein a corresponding sheet was subjected to the same stiffening process but over the whole surface, it was concluded that the E-modulus in the part constituting the facets would be about 1.4 GPa.

The folding pattern had the following parameters:
a=about 1 mm
b=about 2.5 mm
c=about 5 mm
d=about 6 mm
α₀=about 60°
r₁=about 1.5 mm
r₂=about 1.5 mm

The continuous fibre-containing sheets comprising the folding pattern were folded to partly folded sheet products. It was found that the partly folded sheet products obtained could easily be formed into any geometrical form desired including for example spheres and saddle points without breaking. The facets appeared to remain flat irrespective of the degree of shaping. The partly folded sheet product produced from the creped sheet was easier to shape than the partly folded sheet product produced from the sheet which had not been creped.

The tests as given above were repeated for sheets wherein only the grammage was altered to 90 g/m², 150 g/m² and 180 g/m². Partly folded sheet products obtained from these sheets showed very similar results to the partly folded sheet products obtained from the sheets wherein the grammage was 110 g/m².

### Example 2

The fibre-containing sheet according to Example 1 (wherein the grammage was 110 g/m²) was folded to a partly folded sheet product and interposed between liners produced from a pulp consisting of commingled 40% by dry weight of bleached sulphate pulp and 60% by dry weight of PLA fibres. The liners were bonded to the sheet product, acting as a flute, by means of an adhesive.

It was found that the board obtained could be formed into various complex three-dimensional shapes, merely limited by the stretchability of the liners.

### Example 3

Conventional paper board (essentially consisting of wood pulp fibres) was creased using a modified conversion creasing apparatus equipped with double and triple breadth blunt knives to define the folding pattern. Tested samples had a bending stiffness before creasing according to Table 1.

TABLE 1

| | | | Bending stiffness |
|---|---|---|---|
| Sample ID | Grammage (g/m2) | Thickness (microns) | MD/CD (mNm) |
| A | 100 | 110 | 12/6 |
| B | 180 | 200 | 65/30 |
| C | 200 | 230 | 90/40 |
| D | 220 | 260 | 130/60 |
| E | 240 | 300 | 180/80 |
| F | 300 | 400 | 400/180 |

Tests were performed for two different folding patterns. The first folding pattern had the following parameters:
a=about 1 mm
b=about 2.5 mm
c=about 5 mm
d=about 6 mm
α₀=about 60°
r₁=0 mm
r₂=0 mm

In the second folding pattern, the parameters were twice the parameters of the first folding pattern except for α₀ which naturally was the same.

The continuous paper board sample sheets comprising the first folding pattern or the second folding pattern were folded to partly folded sheet products. It was found that the partly folded sheet products obtained could be formed into complex 3D shapes without breaking. Furthermore, it was found easier to form the partly folded sheet products obtained from sheets having a lower grammage than the samples having a higher grammage to each specific 3D geometrical shape.

1. A fibre-containing sheet (31, 51, 61) comprising a folding pattern forming fold lines and facets (35), the folding pattern consisting of a series of parallel straight fold lines (32) extending in a first surface direction of the sheet and a series of zigzag fold lines (33) extending in a second surface direction of the sheet, the straight fold lines (32) being intersected by the zigzag fold lines (33), each zigzag fold line altering course at each and every intersection (34) with a straight fold line, the straight fold lines and zigzag fold lines together defining a grid of facets (35), wherein each facet is parallelogrammatic in shape, each zigzag fold line (33) has a breadth b that is greater than a breadth a of any one of the parallel straight fold lines (32), and fold line breadth is measured perpendicular to the course of the fold line.

2. The fibre-containing sheet according to claim 1, wherein the sheet comprises cellulose fibres and fibres or particulates of at least one of polylactide, polyhydroxyalkanoate, caprolactam or thermoplastic starch.

3. The fibre-containing sheet according to claim 1, wherein a first part of the sheet constituting the facets is stiffened in relation to a second part of the sheet constituting the fold lines.

4. The fibre-containing sheet according to claim 1, wherein the first part of the sheet constituting the facets is stiffened by application of a coating or layer to the first part of the sheet, or by impregnating the first part of the sheet with a stiffening agent.

5. The fibre-containing sheet according to claim 1, wherein the first part of the sheet constituting the facets is stiffened by welding, hardening, or thermopressing of said first part of the sheet.

6. The fibre-containing sheet according to claim 1, wherein all zigzag fold lines (33) have the same breadth b and all parallel straight fold lines (32) have the same breadth a.

7. The fibre-containing sheet according to claim 1, wherein breadth b is at least twice that of breadth a.

8. The fibre-containing sheet according to claim 1, wherein a distance between any two subsequent parallel straight fold lines c, and a distance between any two subsequent zigzag fold lines d is within a ratio of between 1:5 to 5:1, wherein the distance between two fold lines is measured perpendicular to the course of the fold lines.

9. The fibre-containing sheet according to claim 1, wherein the ratio of the distance between any two subsequent zigzag fold lines d and the breadth of each zigzag fold line b is from 2:1 to 10:1.

10. The fibre-containing sheet according to claim 1, wherein an acute angle (α₀) formed by the intersection of the zigzag folding lines and the straight folding lines is from 50° to 85°.

11. The fibre-containing sheet according to claim 1, wherein each facet (35) has rounded corners at least where the zigzag folding lines (33) and the straight folding lines (32) intersect to form an acute angle.

12. The fibre-containing sheet according to claim 1, wherein the sheet is creped.

13. A partly or fully folded sheet product (41, 73) manufactured from the fibre-containing sheet (31, 51, 61) according to claim 1 by folding at least part of the sheet along the fold lines in order to form mountain folds and valley folds, wherein each folded zigzag fold line consists solely of mountain folds (33a) or solely of valley folds (33b), with mountains folds alternating with valley folds from one zigzag fold line to a subsequent zigzag fold line, and wherein each of the folded straight fold lines alternates between valley folds (32a) and mountain folds (32b) in correlation with each intersection with a zigzag fold line.

14. A laminate comprising the partly folded sheet product according to claim 13 and at least one liner.

15. A cardboard or paperboard comprising the partly folded sheet product according to claim 13 and at least one second fibre-containing sheet.

16. A packaging material comprising the partly folded sheet product according to claim 13.

17. A method of producing a fibre-containing sheet comprising a folding pattern, the method comprising the steps of providing a fibre-containing sheet and forming a folding pattern on said sheet such that the folding pattern comprises a series of parallel straight fold lines in a first surface direction of the sheet, the straight fold lines being intersected by zigzag fold lines extending in a second surface direction of the sheet, each zigzag fold line altering course at each and every intersection with a straight fold line, the straight fold lines and zigzag fold lines together defining a grid of facets, wherein each facet is parallelogrammatic in form, and wherein each zigzag fold line has a breadth b that is greater than a breadth a of any one of the parallel straight fold lines, wherein fold line breadth is measured perpendicular to the course of the fold line.

18. The method according to claim 17, wherein the sheet comprises cellulose fibres and fibres or particulates of at least one of polylactide, polyhydroxyalkanoate, caprolactam or thermoplastic starch.

19. The method of producing a fibre-containing continuous sheet according to claim 17, further comprising stiffening a first part of the sheet constituting the facets in relation to a second part of the sheet constituting the fold lines.

20. The method according to claim 19, whereby the first part of the sheet constituting the facets is stiffened by applying a coating or layer to the first part of the sheet or by impregnating the first part of the sheet.

21. The method according to claim 19, whereby the first part of the sheet constituting the facets is stiffened by welding, hardening, or thermopressing of said first part of the sheet.

22. The method according to claim 17, further comprising at least partly folding the sheet along the fold lines in order to form mountain folds and valley folds, wherein each folded zigzag fold line consists solely of mountain folds or solely of valley folds, with mountains folds alternating with valley folds from one zigzag fold line to the subsequent zigzag fold line, and wherein each of the folded straight fold lines alternates between valley folds and mountain folds in correlation with each intersection with a zigzag fold line.

23. The method according to claim 17, further comprising creping the sheet prior to forming the folding pattern.

24. The method according to claim 19, further comprising creping the sheet after forming the folding pattern but prior to stiffening the facets.
